(19) United States
(12) Patent Application Publication
(10) Pub. No.: US 2026/0086504 A1
(43) Pub. Date: Mar. 26, 2026

(54) WATCH COMPRISING A HUMIDITY REGULATION DEVICE INSIDE ITS CASE

(71) Applicant: The Swatch Group Research and Development Ltd, Marin (CH)

(72) Inventors: Marek DOVCIK, Mougins (FR); Nicolas François, Neuchâtel (CH); Sophie Napoli, Neuchâtel (CH)

(73) Assignee: The Swatch Group Research and Development Ltd, Marin (CH)

(21) Appl. No.: 19/283,565

(22) Filed: Jul. 29, 2025

(30) Foreign Application Priority Data
Sep. 20, 2024 (EP) 24201677.20

(51) Int. Cl. G04B 47/00; G04B 37/00

(52) U.S. Cl. CPC G04B 47/00; G04B 37/0008

(57) ABSTRACT

A watch (1) including a watchcase (2), the watchcase (2) including a humidity regulation device (3) inside the watch (2). The humidity regulation device (3) is in the form of a film made of at least one thermoplastic polymer filled with absorbent natural fibres configured to change volume in the presence of water vapour inside the watchcase (2).

### CROSS REFERENCE TO RELATED APPLICATIONS

This application claims priority to European Patent Application No. 24201677.2 filed Sep. 20, 2024, the entire contents of which are incorporated herein by reference.

### Technical Field

The invention relates to a watch comprising a watchcase, the watchcase comprising a humidity regulation device inside the watch.

### Technological Background

The water-resistance of a watch is measured in bars (a bar is a unit of pressure, 1 bar being equivalent to 1 atmosphere (atm)). The degree of water resistance of a watch is often indicated in metres (m). Watches defined as water-resistant are intended for everyday use, which means they must be water-resistant for activities such as swimming or even just taking a shower.

To guarantee water-resistance, watches are generally fitted with a set of water-resistant joints positioned in the assembly points of certain parts of the watch, such as the glass, the bezel and the back, as well as of mobile elements such as the crown and the buttons. Over time and with use, the mechanical properties of the joints change and the water-resistance of the watch can sometimes deteriorate. The watch then becomes more permeable to water or water vapour. This can result in condensation phenomena on the inside face of the watch glass, or worse, oxidation of certain metal components or deterioration of certain polymer components. There is thus a need to be able to check the degree of relative humidity in the watch from time to time without necessarily having to open it, as opening the watchcase would systematically require the joints to be changed and involve a horologist, which is costly. An excessive amount of water vapour in the watch can be an indication that one or more joints need replacing in the short to medium term.

To meet this need, certain watches comprise a device for measuring the degree of relative humidity inside the watch. Such a measuring device consists of an electronic module capable of measuring and recording the values of various environmental parameters, including relative humidity. Due to the small size of such an electronic module, it can be fitted inside a watchcase and measure the degree of relative humidity inside the watchcase using a dedicated sensor. The measured relative humidity values can then be wirelessly transmitted to a watch docking station, typically by infrared or radio frequency. The infrared signal emitted by the electronic module then passes through a transparent portion of the watchcase, typically the glass, and is received by an infrared sensor in the docking station. The user of the watch can then view the measured relative humidity values via a computer connected to the docking station and equipped with dedicated software, or via a smartphone.

However, one drawback of such an electronic measuring device is that it requires a battery or a cell to be able to power the various electronic components. Such a device is therefore highly unsuitable, particularly for mechanical watches. Moreover, in the case of electronic watches, it can adversely affect the autonomy of a product or require the use of a larger-capacity battery, thereby increasing the volume of the watch.

Another drawback is that such a device is relatively bulky and not very discreet inside the watch. In addition, such an electronic measurement device is relatively expensive and therefore impacts the cost of manufacturing the watch.

### SUMMARY OF THE INVENTION

The invention aims in particular to remedy the various drawbacks of these known techniques.

More specifically, one objective of the invention is to provide a material suitable for making elastomer parts designed to be in prolonged direct or indirect contact with the skin and to obtain an elastomer with properties that provide improved comfort while retaining good colourability and good resistance to ageing (UVs, perspiration, aesthetics).

These objectives, and others that will become clearer hereinafter, are achieved according to the invention using a watch comprising a watchcase, the watchcase comprising a humidity regulation device inside the watch, characterised in that the humidity regulation device is in the form of a film made of at least one thermoplastic polymer filled with absorbent natural fibres configured to change volume in the presence of water vapour inside the watchcase.

According to other advantageous variants of the invention:
the thermoplastic polymer is a superabsorbent polymer;
natural fibres are chosen among: cellulose, hemp, ramie, silk;
the film comprises a hydrochromic pigment;
the film comprises a second thermoplastic polymer;
the film is in the form of a flat disc;
only a portion of the disc, in the form of a ring, is absorbent, to form a distinctive pattern;
the film is applied to or under a dial of the watch;
the film is applied to a back of the watch.

### BRIEF DESCRIPTION OF THE DRAWINGS

The purposes, advantages and characteristics of the wristlet provided with a phosphorescent insert will become clearer in the following description through the drawings in which:

FIG. 1 shows a top view of a dial fitted with a humidity regulation device according to the invention, and

FIG. 2 shows a watch fitted with a humidity regulation device according to the invention.

### DETAILED DESCRIPTION

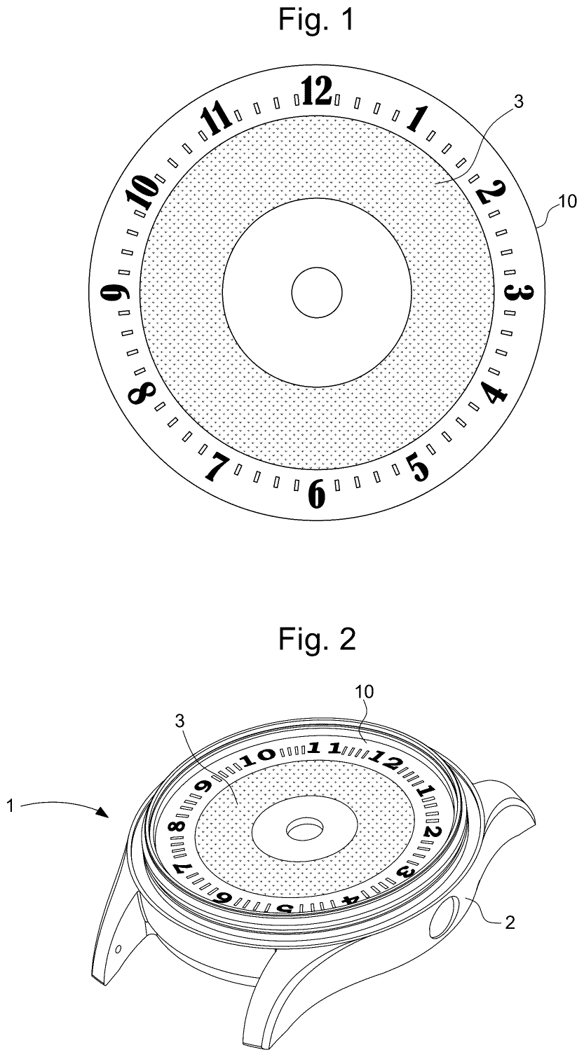

FIG. 1 shows an assembly for measuring the degree of relative humidity inside a watch 2. In the present invention, “degree of humidity” is taken to mean “the ratio between the partial pressure of the water vapour contained in the air and the saturation vapour pressure (or vapour tension) at the same temperature.” In other words, measuring the degree of relative humidity corresponds to calculating the ratio between the water vapour content in the air and its maximum capacity to contain water vapour under the same temperature conditions.

The watch 1 has a watchcase 2. The watchcase 2 comprises a device 3 for measuring the degree of relative humidity inside the watch 2. The watchcase 2 also comprises a middle, a dial 10 and time display means (the latter not shown in the figures for clarity reasons), the measuring device 3 being arranged, for example, inside the watchcase 2 on the dial 10, as illustrated in FIG. 1.

The measuring device 3 is a device in the form of a thin film made of at least one thermoplastic polymer filled with absorbent natural fibres and superabsorbent polymers configured to change volume in the presence of water vapour inside the watchcase. The film can comprise a second thermoplastic polymer or even be composed of several thermoplastic polymers.

According to a preferred embodiment of the invention, the superabsorbent polymer is chosen from the family of cross-linked polyacrylates.

The thermoplastic polymer used comprises at least one additive such as superabsorbent polymers composed of sodium or potassium polyacrylates with a cation concentration greater than 0.05 g/kg. The number of cations is generally greater than 5% of the polymer weight.

The thermoplastic polymer also comprises natural fibres chosen among: cellulose, hemp, ramie and silk. Such fibres have good absorbent properties and can therefore enhance the absorbent effect of the polymer.

The thin film is configured to change volume and/or colour in the presence of water vapour inside the watchcase. To this end, the film is deposited, for example, on the dial, as shown in FIG. 1, and comprises a hydrochromic pigment that has been added to the thermoplastic polymer.

The film is in the form of a flat disc, the centre of which can be cut to form a ring.

According to one embodiment of the invention, only a portion of the disc, in the form of a ring, is absorbent, to form a distinctive pattern when the film absorbs humidity.

The film can be applied to or under a watch dial, depending on whether or not the absorption film is to be visible. The film can also be applied to the back of the watch.

1. A watch (1) comprising a watchcase (2), the watchcase (2) comprising a humidity regulation device (3) inside the watch (2), wherein the humidity regulation device (3) is in the form of a film made of at least one thermoplastic polymer filled with superabsorbent polymers and absorbent natural fibres configured to change volume in the presence of water vapour inside the watchcase (2).

2. The watch according to claim 1, wherein the thermoplastic polymer is a superabsorbent polymer.

3. The watch according to claim 1, wherein the natural fibres are chosen among: cellulose, hemp, ramie, silk.

4. The watch according to claim 1, wherein the film comprises a hydrochromic pigment.

5. The watch according to claim 1, wherein the film comprises a second thermoplastic polymer.

6. The watch according to claim 1, wherein the film is in the form of a flat disc.

7. The watch according to claim 6, wherein only a portion of the disc, in the form of a ring, is absorbent, to form a distinctive pattern.

8. The watch according to claim 1, wherein the film is applied to or under a dial (10) of the watch.

9. The watch according to claim 1, wherein the film is applied to a back of the watch.
